(19) United States
(12) Patent Application Publication
(10) Pub. No.: US 2006/0055166 A1
(43) Pub. Date: Mar. 16, 2006

(54) Archival system for natural or other entities

(76) Inventor: Charles Garvin Crawford, Northern (IE)

Correspondence Address: OSTROLENK FABER GERB & SOFFEN, 1180 AVENUE OF THE AMERICAS, NEW YORK, NY, 100368403, US

(21) Appl. No.: 10/528,505

(22) PCT Filed: Sep. 18, 2003
(86) PCT No.: PCT/GB03/04126

§ 371 Date: Mar. 18, 2005

(30) Foreign Application Priority Data
Sep. 18, 2002 (GB) 0221617.4

(51) Int. Cl. B42D 1/00

(52) U.S. Cl. 281/21.1

(57) ABSTRACT

An archival system is formed from one or more carriers (10) or the loose or detachable pages (14, 16) of one or more carriers (10) when completed and positioned in a ring-type binder or other suitable binder or folder with one or more interleaved indexing sheets. The indexing sheets are to separate completed carriers (10) or pages (14, 16) by subject matter or topic. Each carrier (10) has one or more pages (14) of a first type fixed to a spine (18) formed along one side of the carrier (10). One or more pages (16) of a second type are provided. The or each page (14) of the first type are pre-printed with introductory statements and/or notations intended to be completed by the sender, and the or each page (16) of the second type having provision to receive and hold one or more photographs, press cuttings or other items of record about or of interest to the intended receiver of the carrier.

This invention relates to an archival system for natural or other legal or non-legal entities. Archives are collections of records. This invention relates particularly to means enabling the creation of such records in a given format, such format being based on the use of a social document in the nature of a story or occasion card or carrier to be used on occasions to send messages of pleasure, happiness, success, congratulation, celebration, commemoration, gratitude, invitation, regret or sympathy greetings or other remembrances. A conventional card may be pre-printed with relevant text(s) or the text being left to be written by the sender; or a combination of both, and may have front and back leaves or may alternatively have a single leaf. The single leaf or at least the front leaf of the card may have a design thereon normally, but not always, having relevance to the particular occasion. Heretofore, conventional occasion cards when received may be displayed for a period of time and then put away for retention, but generally, they are thrown away. Such an existing card will hereafter be referred to as “a card of the type stated”

An object of the present invention is to provide a card wholly or partly intended for retention as a historical record and in which a facility is provided for information known to the sender about the recipient or relative or friend of the recipient to be written on or forwarded with the card. The archival system enables the transformation of such social documents into collectable historical artifacts in a standardised format promoting family or entity research with relative ease and simplicity.

Accordingly, one aspect of the present invention is a carrier in which one or more pages of a first type are fixed to a spine formed along one side of the carrier, and one or more pages of a second type are provided, the or each page of the first type being pre-printed with introductory statements and/or notations intended to be completed by the sender, and the or each page of the second type having provision to receive and hold one or more photographs, press cuttings or other items of record about or of interest to the intended receiver of the carrier.

Preferably, the carrier is a card of the type stated. The card desirably has front and back leaves. The spine is beneficially formed internally of a fold between the leaves. Additionally, a marginal portion of the front or back leaf adjacent to the spine may be secured to the back or front leaf respectively to form a pocket in which the one or more pages of the second type are held. A corner pocket is desirably provided at least at the top or bottom of the inside face at the outside edges of the front or back leaf to receive the respective corners of the one or more pages of the second type.

Preferably also, a second series of pages of the first type are provided as loose leaf to be inserted into the pocket.

Preferably further, the back leaf of the carrier has push out apertured tabs adjacent to the spine.

The pages of the first and/or second type are preferably detachable and are preferably peelable from the spine or alternatively a side portion of each page is secured to the spine with the rest of the page being separable therefrom by a line of perforations or like provision to enable the rest of the page to be detachable along the line of perforations. The detachable pages are desirably pre-punched suitable for inserting into a ring-type or other suitable binder or folder.

According to a second aspect of the present invention, an archival system is formed from one or more carriers or the loose or detachable pages of one or more carriers when completed and positioned in a ring-type binder or other suitable binder or folder with one or more interleaved indexing sheets, the indexing sheets being to separate completed carriers by subject matter or topic.

Embodiments of the present invention will now be described, by way of example, with reference to the accompanying drawings in which:

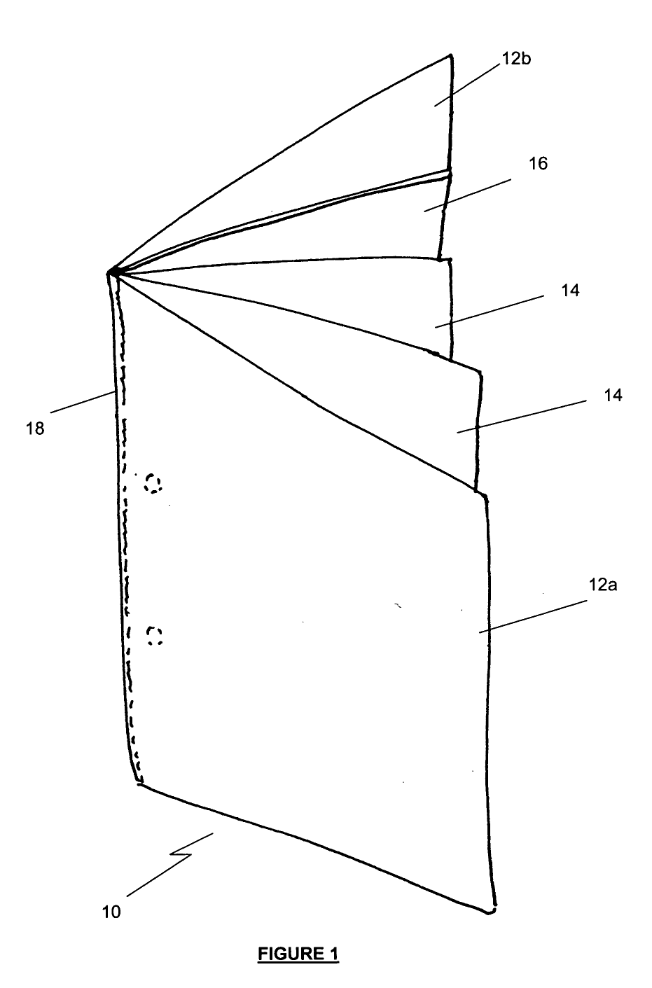

FIG. 1 is a perspective view of a first embodiment of a carrier;

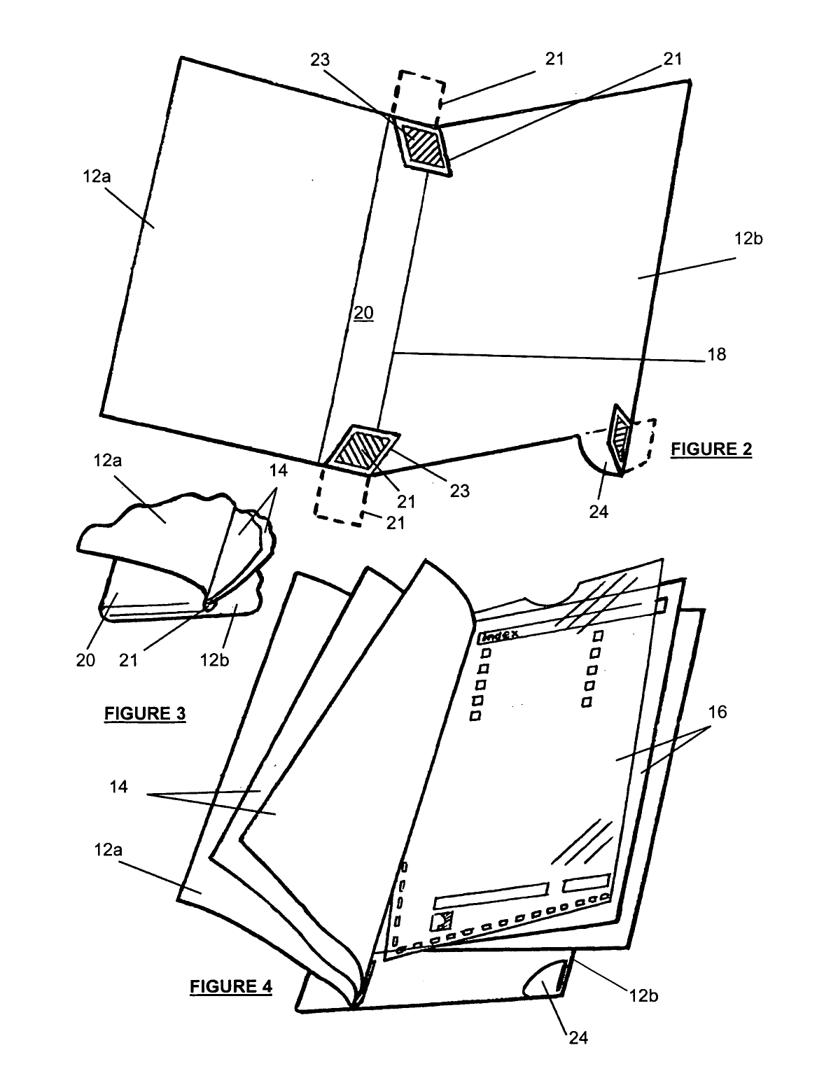

FIG. 2 is a perspective view of a second embodiment of a carrier, the view showing tags partly folded with adhesive zones, the tags in broken line being as per a blank, the adhesive zones being attachable to a back leaf of the carrier;

FIG. 3 is a detail of a bottom left hand corner of the erected carrier shown in FIG. 2;

FIG. 4 is a perspective view of the carrier shown in FIGS. 2 and 3 with fixed pages of the first type and loose pages of the first and second types;

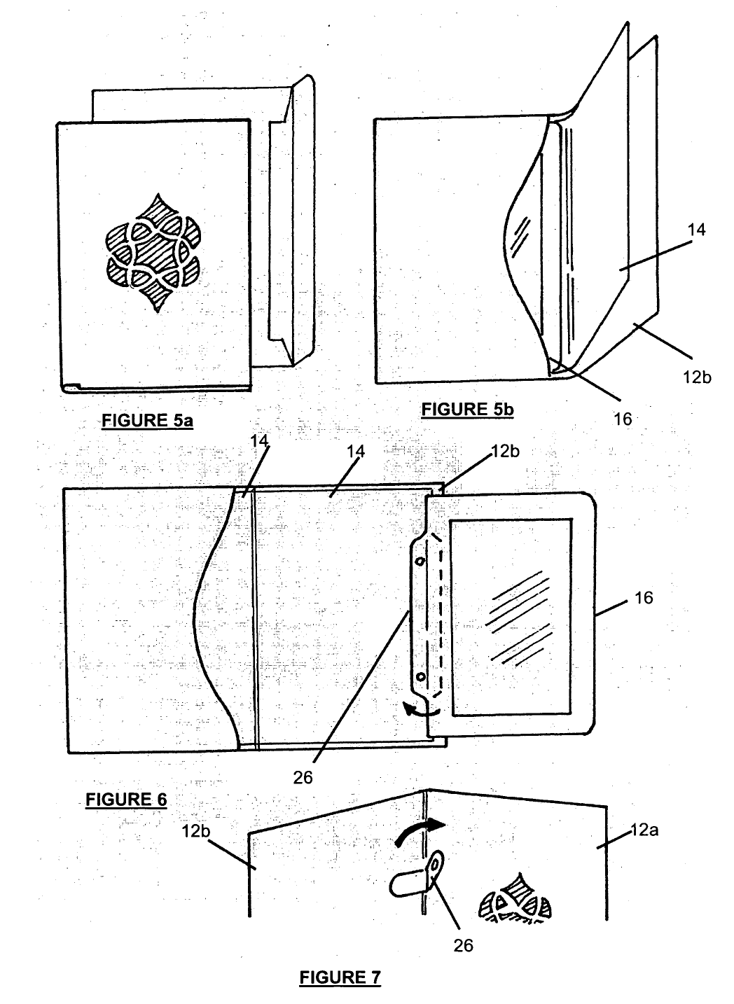

FIGS. 5A and 5B are plan views respectively of a third embodiment of a carrier overlying an envelope and a carrier partly inserted into the envelope, a loose page of a second type being shown;

FIG. 6 is a plan view of the carrier shown in FIG. 5B with the loose page withdrawn and an apertured tab unfolded, the broken lines indicating the tabs normal unused position;

FIG. 7 is a detail of a reverse plan view of the carrier showing an apertures tab pushed out from the back leaf of the carrier;

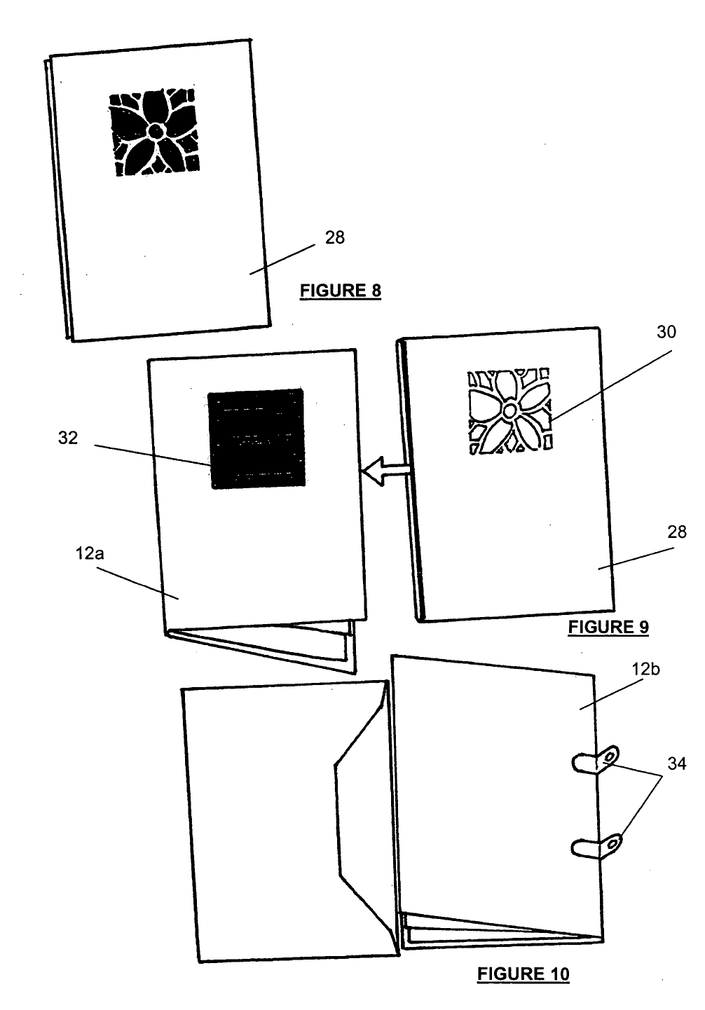

FIG. 8 is a plan view of a fourth embodiment of a carrier having a cut-out design on a front leaf of the carrier;

FIG. 9 is a part perspective view of a removable part of a carrier shown in FIG. 8 having the cut-out design shown removed from a page of the first type, which has a coloured or patterned area for registry alignment behind the cut-out; and

FIG. 10 is a plan view of the back leaf of the carrier shown in FIG. 9 with apertured tabs extended, and the reverse of an envelope.

Referring to FIG. 1 of the drawings, a carrier provided in the form of a card 10 of the type stated has one or more detachable pages 14 of a first type (two are shown) and one or more detachable pages 16 (one is shown) of a second type fixed to a spine 18 formed along one side of the card 10. Each page 14 of the first type is pre-printed with introductory statements intended to be completed by the sender, and the page or a series of pockets formed by subdividing the series pocket 16 of the second type has provision such as single full size translucent pocket or translucent peelable sheets on each side of a card or a strip or corner mounting to receive and hold one or more photographs, press cuttings or other items of record about or of interest to the intended recipient of the card.

The card 10 has front and back leaves 12A, 12B formed from folding a single sheet of paper or cardboard and the spine 18 is formed internally of the leaves 12A, 12B at the fold.

The detachable pages 14, 16 are peelable or tearable from the spine 18 and are pre-punched suitable for inserting into a ring-type or other suitable binder.

In a first modification, the pages 14,16 are capable of being re-adhered to the spine 18.

In a second modification, a page of a third type may be provided. Such a page of the third type may be pre-printed with a series of headings to act as an aid memoir for different aspects of the memory story to be written.

In a second embodiment as shown in FIGS. 2, 3 and 4 and in which like parts are denoted by like numerals, the carrier has a marginal portion 20 of the front leaf 12A adjacent to the spine 18 for securing to the back leaf 12B to form a pocket 22 (FIG. 3) into which the one or more pages 16 of the second type are held, together with any loose pages 14 of the fist type. The portion 20 is secured by tags 21 having adhesing zones 23 which are attachable to the back leaf 12B. A corner pocket 24 is provided at the bottom of the inside face at the outside edge of the back leaf 12B, the corner pocket 24 being to receive the respective corners of the pages 14, 16.

In a third embodiment as shown in FIGS. 5A, 5B, 6 and 7 and in which like parts are denoted by like numerals, the carrier has a detachable page 16 in the form of a pocket having a border frame and a push-out apertured tab 26.

In a fourth embodiment as shown in FIGS. 8, 9 and 10 and in which like parts are denoted by like numerals, the carrier is a card with a front leaf with an artistic cut-out 30 formed as a sleeve 28 in which a card of the type stated according to the first embodiment is slid, the front face of the card having a coloured or patterned area 32 for registry alignment with the cut-out 30 on full insertion into the sleeve 28. The back leaf 12B of the card has two push-out apertured tabs 34 as shown for insertion into a ring-tyre binder or other suitable binder or folder.

In a fifth embodiment (not shown), a side portion of each page 14, 16 is secured to the spine 18 with the rest of the page 14, 16 being separable therefrom by a line of perforations or like provision to enable the rest of the page to be detachable along the line of perforations.

The carrier may alternatively be a pocket into which the pages of the first and second types fixed together by the spine are inserted, the pocket being formed from translucent o, or transparent or opaque material with or without screen printing thereon. The material may be of plastics or cellulose.

The pages 14, 16 are used to be completed by the sender to record details of some event(s) within his/her knowledge relating to the intended recipient of the card or to some deceased relative, friend or acquaintance of the recipient. On receipt of the card, the recipient can keep the card for safe-keeping or can detach the pages 14,16 and insert them into a ring-type or other suitable record book for safekeeping.

Detachable pages of this invention are suitable for use with a Personal Story Organiser according to the invention described in my co-pending International Patent Application PCT/GB02/02041. Pads of loose pages of the first type for hand writing or computer typing may be provided as well as packs of pages of the second type which may take the form of apertured clear pockets or paper pockets having obverse framed borders.

The range of cards available may include the following:

1. Sympathy—Something friends can do—a personal story of remembrance

2. Leaving—Good Luck! You may be leaving but you won't be forgotten

3. Thank You—So you know how much you are appreciated

4. Birthday—Congratulations—A story of the year you can be proud of

5. Xmas—Happy Xmas One of the great stories of your year

6. Wedding—(for bride/groom/maid of honour/best man/parent) You did so well.

This is to commemorate your wonderful day

7. New Baby—Congratulations! A pregnancy to remember (as well as a baby!)

8. Well done—Here's to a great performance

9. Reunion—This is me, how about you?

10. Graduation—Well done

11. Courage—To recognise your bravery

12. Service—To honour the service you have given to others

13. Teamwork—To celebrate your part in our team

14. My love—Another reason why I love you

15. Retirement—Congratulations on your career

16. Farewell—This is for you to remember me by

17. Holiday—To thank you for a wonderful time

18. Our Class—To help networking in the future

The story card of the present invention is not for throwing away but for retention as a historical record of treasured memories and capable of being assembled with others of like kind or with other information in the ring-type or other suitable record book.

Variations and other modifications can be made without departing from the scope of the invention described above and claimed hereinafter.

1. A carrier in which one or more pages of a first type are fixed to a spine formed along one side of the carrier, and one or more pages of a second type are provided, the or each page of the first type being pre-printed with introductory statements and/or notations intended to be completed by the sender, and the or each page of the second type having provision to receive and hold one or more photographs, press cuttings or other items of record about or of interest to the intended receiver of the carrier.

2. A carrier as claimed in claim 1, wherein the carrier is a card of the type stated with front and back leaves and the spine is formed internally of a fold between the leaves.

3. A carrier as claimed in claim 2, wherein a marginal portion of the front or back leaf adjacent to the spine is secured to the back or front leaf respectively to form a pocket in which the one or more pages of the second type are held.

4. A carrier as claimed in claim 3, wherein a corner pocket is provided at least at the top or bottom of the inside face at the outside edges of the front or back leaf to receive the respective corners of the one or more pages of the second type.

5. A carrier as claimed in claim 3, wherein a second series of pages of the first type are provided as loose leaf to be inserted into the pocket.

6. A carrier as claimed in claim 2, wherein the back leaf of the carrier has push out apertured tabs adjacent to the spine.

7. A carrier as claimed in claim 1, wherein the pages of the first and/or second type are detachable by being peelable from the spine.

8. A carrier as claimed in claim 1, wherein a side portion of each page is secured to the spine with the rest of the page being separable therefrom by a line of perforations or like provision to enable the rest of the page to be detachable along the line of perforations.

9. A carrier as claimed in claim 7, wherein the detachable pages are pre-punched suitable for inserting into a ring-type or other suitable binder or folder.

10. An archival system is formed from one or more carriers as defined in claim 1 or the loose or detachable pages of one or more of the carriers when completed and positioned in a ring-type binder or other suitable binder or folder and with one or more interleaved indexing sheets, the indexing sheets being to separate completed carriers or pages by subject matter or topic.

11. (canceled)

12. (canceled)
